(19) United States
(12) Patent Application Publication
(10) Pub. No.: US 2026/0032436 A1
(43) Pub. Date: Jan. 29, 2026

(54) APPARATUS CONFIGURED TO ACCEPT OR REJECT A CONNECTION REQUEST BASED ON AN OUTCOME OF A NETWORK SLICE SPECIFIC AUTHENTICATION AND AUTHORIZATION PROCEDURE

(71) Applicant: Nokia Technologies Oy, Espoo (FI)

(72) Inventors: Alessio CASATI, WEST MOLESEY (GB); Laurent THIÉBAUT, Massy (FR)

(21) Appl. No.: 19/119,523

(22) PCT Filed: Nov. 6, 2023
(86) PCT No.: PCT/EP2023/080797

§ 371 Date: Apr. 9, 2025

(30) Foreign Application Priority Data
Nov. 29, 2022 (GB) 2217933.7

(51) Int. Cl. H04W 12/06; H04W 60/00; H04W 76/10

(52) U.S. Cl. CPC H04W 12/06; H04W 60/00; H04W 76/10

(57) ABSTRACT

There is provided an apparatus comprising receiving, from a user equipment, a request for a network connection, the request comprising information indicating whether the user equipment supports network slice specific authentication and authorization; determining whether a network slice associated with the requested connection is subject to network slice specific authentication and authorization; determining, based on the request, whether the user equipment supports network slice specific authentication and authorization; and responsive to determining that the network slice is subject to network slice specific authentication and authorization and determining that the user equipment supports network slice specific authentication and authorization, accepting or rejecting the request based on information indicating the outcome of a network slice specific authentication and authorization procedure for the user equipment for the network slice associated with the requested connection.

### FIELD

The present application relates to a method, apparatus, system and computer program and in particular but not exclusively to accepting or rejecting a connection request based on an outcome of a network slice specific authentication and authorization procedure.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

According to an aspect, there is provided an apparatus comprising means for: receiving, from a user equipment, a request for a network connection, the request comprising information indicating whether the user equipment supports network slice specific authentication and authorization; determining whether a network slice associated with the requested connection is subject to network slice specific authentication and authorization; determining, based on the request, whether the user equipment supports network slice specific authentication and authorization; and responsive to determining that the network slice is subject to network slice specific authentication and authorization and determining that the user equipment supports network slice specific authentication and authorization, accepting or rejecting the request based on information indicating the outcome of a network slice specific authentication and authorization procedure for the user equipment for the network slice associated with the requested connection.

The accepting or rejecting may comprise: determining whether there is locally stored information indicating that network slice specific authentication and authorization was previously executed successfully for the user equipment for the network slice associated with the requested connection; and accepting the request in response to determining that there is locally stored information indicating that network slice specific authentication and authorization was previously executed successfully for the user equipment for the network slice associated with the requested connection.

The locally stored information may comprise session information for the user equipment for the network slice associated with the requested connection or cached network slice specific authentication and authorization status information

The accepting or rejecting may comprise: requesting, from a home subscriber server and/or unified data management entity, an indication of whether network slice specific authentication and authorization status information is available for any first entity or access and mobility management function; receiving, from the home subscriber server and/or unified data management entity, a response comprising information indicating whether there is network slice specific authentication and authorization status information available; and accepting the request in response to determining that there is network slice specific authentication and authorization status information available indicating the network slice specific authentication and authorization was successful for the network slice associated with the requested connection; or rejecting the request in response to determining that the status information indicates the network slice specific authentication and authorization was not successfully executed for the network slice associated with the requested connection; or determining the need to perform network slice specific authentication and authorization when there is no network slice specific authentication and authorization status information available.

When there is status information available, the response may further comprise the status information for the network slice subject to network slice specific authentication and authorization.

The information indicating whether there is network slice specific authentication and authorization status information available may comprise information indicating whether there is network slice specific authentication and authorization status information available for any first entity or access and mobility management function.

The means may be for, responsive to determining the need to perform network slice specific authentication and authorization: establishing the requested network connection; sending, to the user equipment, an indication that network slice specific authentication and authorization is pending; and performing network slice specific authentication and authorization.

The indication may comprise information for causing the user equipment to refrain from performing transmission using the requested network connection.

The means may be for: accepting or rejecting the request based on a result of performing the network slice specific authentication and authorization; and when the request is accepted, sending, to the user equipment, information indicating that the request is accepted and that the user equipment may perform transmission using the established network connection; or when the request is rejected, releasing the network connection and sending an instruction to the user equipment to deactivate the network connection with an indication that the network slice specific authentication and authorization was not successfully executed for the network slice associated with the requested connection.

The means may be for: responsive to accepting or rejecting the request, locally storing information indicating that network slice specific authentication and authorization was previously executed for the user equipment for the network slice associated with the requested connection and information indicating whether the network slice specific authentication and authorization was successful or unsuccessful.

The means may be for: receiving, from a network slice specific authentication and authorization function, a request for re-authorization of a user equipment for a network slice; executing network slice specific authentication and authorization for a connection of the user equipment associated with said network slice; and updating the locally stored information to indicate that the user equipment is authorized for the network slice associated with the connection.

The means may be for releasing the one or more network connections for the user equipment associated with the network slice.

The means may be for: receiving, from a network slice specific authentication and authorization function, a request for revocation of authorization of the user equipment for a network slice associated with one or more connections of the user equipment; based on the request for revocation, releasing the one or more network connections for the user equipment associated with the network slice; and updating the locally stored information and information stored at the home subscriber server entity and/or unified data management entity to indicate that the user equipment is no longer authorized for the network slice associated with the requested connection.

According to an aspect, there is provided an apparatus comprising means for: sending, from a user equipment to a first entity, a request for a network connection, the request comprising information indicating whether the user equipment supports network slice specific authentication and authorization; and receiving, from the first entity and based on the request, information indication whether the request is accepted or rejected based on an outcome of a network slice specific authentication and authorization procedure for the user equipment for a network slice associated with the requested connection.

The outcome of the network slice specific authentication and authorization procedure may be: an outcome of a network slice specific authentication and authorization procedure performed in response to the request for the network connection; or an outcome of a network slice specific authentication and authorization procedure performed in response to an earlier request from the user equipment.

The means may be for: establishing the requested network connection; receiving, from the first entity, an indication that the network connection is accepted but that network slice specific authentication and authorization is pending; and refraining from performing transmission using the requested network connection based on the indication that network slice specific authentication and authorization is pending.

The means may be for: receiving, from the first entity, information indicating that the user equipment may perform transmission using the established network connection; or receiving, from the first entity, an instruction to release the network connection, and releasing the network connection based on the instruction.

According to an aspect, there is provided an apparatus comprising means for: receiving, from a first entity, a request for an indication of whether network slice specific authentication and authorization status information is available for a user equipment and a network slice; determining, based on the request, whether there is network slice specific authentication and authorization status information available; and based on the determining, sending, to the first entity, a response comprising information indicating whether there is network slice specific authentication and authorization status information available.

The determining may comprise: checking for network slice specific authentication and authorization status information stored in association with any data connection involving the same network slice for the user equipment or any registration for the user equipment.

According to an aspect, there is provided an apparatus comprising means for: receiving, at an access and mobility management function from a user equipment, a registration request associated with a network slice subject to network slice specific authentication and authorization; determining, based on the request, network slice specific authentication and authorization status information associated with the network slice subject to network slice specific authentication and authorization; and based on the determined status information, accepting or rejecting the request.

Determining the status information may comprise: determining the status information based on information stored at the access and mobility management function; or obtaining the status information from a unified data management function.

Determining the status information may comprise: performing a network slice specific authentication and authorization procedure based on the request; and determining the status information based on an outcome of the network slice specific authentication and authorization procedure.

The means may be for: updating network slice specific authentication and authorization status information stored at the access and mobility management function and/or unified data management function based on an outcome of the network slice specific authentication and authorization procedure.

The accepting or rejecting the request may comprise: determining that the status information indicates that the user equipment is authorized and accepting the request; or determining that the status information indicates that the user equipment is not authorized and rejecting the request.

The means may be for: sending, to the user equipment, information indicating whether the request is accepted or rejected.

The means may be for: receiving a reauthorization request associated with an authorization of the user equipment; in response to the reauthorization request, performing network slice specific authentication and authorization procedure; and updating network slice specific authentication and authorization status information stored at the access and mobility management function based on an outcome of the network slice specific authentication and authorization procedure.

The means may be for: updating, at a unified data management function, status information for the access and mobility management function based on an outcome of the network slice specific authentication and authorization procedure.

The means may be for: receiving, at the access and mobility management function, a revocation request associated with an authorization of the user equipment for a given network slice; deleting the registration of the user equipment at the access and mobility management function for the given network slice; and updating network slice specific authentication and authorization status information stored at the access and mobility management function to indicate that the user equipment is not authorized for the given network slice.

The means may be for: updating, at a unified data management function, status information for the access and mobility management function based on deleting the registration of the user equipment at the access and mobility management function for the given network slice.

According to an aspect, there is provided an apparatus comprising at least one processor and at least one memory storing instructions that, when executed by the at least one processor, cause the apparatus at least to: receive, from a user equipment, a request for a network connection, the request comprising information indicating whether the user equipment supports network slice specific authentication and authorization; determine whether a network slice associated with the requested connection is subject to network slice specific authentication and authorization; determine, based on the request, whether the user equipment supports network slice specific authentication and authorization; and responsive to determining that the network slice is subject to network slice specific authentication and authorization and determining that the user equipment supports network slice specific authentication and authorization, accept or reject the request based on information indicating the outcome of a network slice specific authentication and authorization procedure for the user equipment for the network slice associated with the requested connection.

The at least one processor may be configured to cause the apparatus to: determine whether there is locally stored information indicating that network slice specific authentication and authorization was previously executed successfully for the user equipment for the network slice associated with the requested connection; and accept the request in response to determining that there is locally stored information indicating that network slice specific authentication and authorization was previously executed successfully for the user equipment for the network slice associated with the requested connection.

The locally stored information may comprise session information for the user equipment for the network slice associated with the requested connection or cached network slice specific authentication and authorization status information

The at least one processor may be configured to cause the apparatus to: request, from a home subscriber server and/or unified data management entity, an indication of whether network slice specific authentication and authorization status information is available for any first entity or access and mobility management function; receive, from the home subscriber server and/or unified data management entity, a response comprising information indicating whether there is network slice specific authentication and authorization status information available; and accept the request in response to determining that there is network slice specific authentication and authorization status information available indicating the network slice specific authentication and authorization was successful for the network slice associated with the requested connection; or reject the request in response to determining that the status information indicates the network slice specific authentication and authorization was not successfully executed for the network slice associated with the requested connection; or determine the need to perform network slice specific authentication and authorization when there is no network slice specific authentication and authorization status information available.

When there is status information available, the response may further comprise the status information for the network slice subject to network slice specific authentication and authorization.

The information indicating whether there is network slice specific authentication and authorization status information available may comprise information indicating whether there is network slice specific authentication and authorization status information available for any first entity or access and mobility management function.

The at least one processor may be configured to cause the apparatus to, responsive to determining the need to perform network slice specific authentication and authorization: establish the requested network connection; send, to the user equipment, an indication that network slice specific authentication and authorization is pending; and perform network slice specific authentication and authorization.

The indication may comprise information for causing the user equipment to refrain from performing transmission using the requested network connection.

The at least one processor may be configured to cause the apparatus to: accept or reject the request based on a result of performing the network slice specific authentication and authorization; and when the request is accepted, send, to the user equipment, information indicating that the request is accepted and that the user equipment may perform transmission using the established network connection; or when the request is rejected, release the network connection and send an instruction to the user equipment to deactivate the network connection with an indication that the network slice specific authentication and authorization was not successfully executed for the network slice associated with the requested connection.

The at least one processor may be configured to cause the apparatus to: responsive to accepting or rejecting the request, locally store information indicating that network slice specific authentication and authorization was previously executed for the user equipment for the network slice associated with the requested connection and information indicating whether the network slice specific authentication and authorization was successful or unsuccessful.

The at least one processor may be configured to cause the apparatus to: receive, from a network slice specific authentication and authorization function, a request for re-authorization of a user equipment for a network slice; execute network slice specific authentication and authorization for a connection of the user equipment associated with said network slice; and update the locally stored information to indicate that the user equipment is authorized for the network slice associated with the connection.

The at least one processor may be configured to cause the apparatus to release the one or more network connections for the user equipment associated with the network slice.

The at least one processor may be configured to cause the apparatus to: receive, from a network slice specific authentication and authorization function, a request for revocation of authorization of the user equipment for a network slice associated with one or more connections of the user equipment; based on the request for revocation, release the one or more network connections for the user equipment associated with the network slice; and update the locally stored information and information stored at the home subscriber server entity and/or unified data management entity to indicate that the user equipment is no longer authorized for the network slice associated with the requested connection.

According to an aspect, there is provided an apparatus comprising at least one processor and at least one memory storing instructions that, when executed by the at least one processor, cause the apparatus at least to: send, from a user equipment to a first entity, a request for a network connection, the request comprising information indicating whether the user equipment supports network slice specific authentication and authorization; and receive, from the first entity and based on the request, information indication whether the request is accepted or rejected based on an outcome of a network slice specific authentication and authorization procedure for the user equipment for a network slice associated cwith the requested connection.

The outcome of the network slice specific authentication and authorization procedure may be: an outcome of a network slice specific authentication and authorization procedure performed in response to the request for the network connection; or an outcome of a network slice specific authentication and authorization procedure performed in response to an earlier request from the user equipment.

The at least one processor may be configured to cause the apparatus to: establish the requested network connection; receive, from the first entity, an indication that the network connection is accepted but that network slice specific authentication and authorization is pending; and refrain from performing transmission using the requested network connection based on the indication that network slice specific authentication and authorization is pending.

The at least one processor may be configured to cause the apparatus to: receive, from the first entity, information indicating that the user equipment may perform transmission using the established network connection; or receive, from the first entity, an instruction to release the network connection, and releasing the network connection based on the instruction.

According to an aspect, there is provided an apparatus comprising at least one processor and at least one memory storing instructions that, when executed by the at least one processor, cause the apparatus at least to: receive, from a first entity, a request for an indication of whether network slice specific authentication and authorization status information is available for a user equipment and a network slice; determine, based on the request, whether there is network slice specific authentication and authorization status information available; and based on the determining, send, to the first entity, a response comprising information indicating whether there is network slice specific authentication and authorization status information available.

The at least one processor may be configured to cause the apparatus to: check for network slice specific authentication and authorization status information stored in association with any data connection involving the same network slice for the user equipment or any registration for the user equipment.

According to an aspect, there is provided an apparatus comprising at least one processor and at least one memory storing instructions that, when executed by the at least one processor, cause the apparatus at least to: receive, at an access and mobility management function from a user equipment, a registration request associated with a network slice subject to network slice specific authentication and authorization; determine, based on the request, network slice specific authentication and authorization status information associated with the network slice subject to network slice specific authentication and authorization; and based on the determined status information, accept or reject the request.

The at least one processor may be configured to cause the apparatus to: determine the status information based on information stored at the access and mobility management function; or obtain the status information from a unified data management function.

The at least one processor may be configured to cause the apparatus to: perform a network slice specific authentication and authorization procedure based on the request; and determine the status information based on an outcome of the network slice specific authentication and authorization procedure.

The at least one processor may be configured to cause the apparatus to: update network slice specific authentication and authorization status information stored at the access and mobility management function and/or unified data management function based on an outcome of the network slice specific authentication and authorization procedure.

The at least one processor may be configured to cause the apparatus to: determine that the status information indicates that the user equipment is authorized and accept the request; or determine that the status information indicates that the user equipment is not authorized and reject the request.

The at least one processor may be configured to cause the apparatus to: send, to the user equipment, information indicating whether the request is accepted or rejected.

The at least one processor may be configured to cause the apparatus to: receive a reauthorization request associated with an authorization of the user equipment; in response to the reauthorization request, perform network slice specific authentication and authorization procedure; and update network slice specific authentication and authorization status information stored at the access and mobility management function based on an outcome of the network slice specific authentication and authorization procedure.

The at least one processor may be configured to cause the apparatus to: update, at a unified data management function, status information for the access and mobility management function based on an outcome of the network slice specific authentication and authorization procedure.

The at least one processor may be configured to cause the apparatus to: receive, at the access and mobility management function, a revocation request associated with an authorization of the user equipment for a given network slice; delete the registration of the user equipment at the access and mobility management function for the given network slice; and update network slice specific authentication and authorization status information stored at the access and mobility management function to indicate that the user equipment is not authorized for the given network slice.

The at least one processor may be configured to cause the apparatus to: update, at a unified data management function, status information for the access and mobility management function based on deleting the registration of the user equipment at the access and mobility management function for the given network slice

According to an aspect, there is provided a method comprising: receiving, from a user equipment, a request for a network connection, the request comprising information indicating whether the user equipment supports network slice specific authentication and authorization; determining whether a network slice associated with the requested connection is subject to network slice specific authentication and authorization; determining, based on the request, whether the user equipment supports network slice specific authentication and authorization; and responsive to determining that the network slice is subject to network slice specific authentication and authorization and determining that the user equipment supports network slice specific authentication and authorization, accepting or rejecting the request based on information indicating the outcome of a network slice specific authentication and authorization procedure for the user equipment for the network slice associated with the requested connection.

The accepting or rejecting may comprise: determining whether there is locally stored information indicating that network slice specific authentication and authorization was previously executed successfully for the user equipment for the network slice associated with the requested connection; and accepting the request in response to determining that there is locally stored information indicating that network slice specific authentication and authorization was previously executed successfully for the user equipment for the network slice associated with the requested connection.

The locally stored information may comprise session information for the user equipment for the network slice associated with the requested connection or cached network slice specific authentication and authorization status information

The accepting or rejecting may comprise: requesting, from a home subscriber server and/or unified data management entity, an indication of whether network slice specific authentication and authorization status information is available for any first entity or access and mobility management function; receiving, from the home subscriber server and/or unified data management entity, a response comprising information indicating whether there is network slice specific authentication and authorization status information available; and accepting the request in response to determining that there is network slice specific authentication and authorization status information available indicating the network slice specific authentication and authorization was successful for the network slice associated with the requested connection; or rejecting the request in response to determining that the status information indicates the network slice specific authentication and authorization was not successfully executed for the network slice associated with the requested connection; or determining the need to perform network slice specific authentication and authorization when there is no network slice specific authentication and authorization status information available.

When there is status information available, the response may further comprise the status information for the network slice subject to network slice specific authentication and authorization.

The information indicating whether there is network slice specific authentication and authorization status information available may comprise information indicating whether there is network slice specific authentication and authorization status information available for any first entity or access and mobility management function.

The method may comprise, responsive to determining the need to perform network slice specific authentication and authorization: establishing the requested network connection; sending, to the user equipment, an indication that network slice specific authentication and authorization is pending; and performing network slice specific authentication and authorization.

The indication may comprise information for causing the user equipment to refrain from performing transmission using the requested network connection.

The method may comprise: accepting or rejecting the request based on a result of performing the network slice specific authentication and authorization; and when the request is accepted, sending, to the user equipment, information indicating that the request is accepted and that the user equipment may perform transmission using the established network connection; or when the request is rejected, releasing the network connection and sending an instruction to the user equipment to deactivate the network connection with an indication that the network slice specific authentication and authorization was not successfully executed for the network slice associated with the requested connection.

The method may comprise: responsive to accepting or rejecting the request, locally storing information indicating that network slice specific authentication and authorization was previously executed for the user equipment for the network slice associated with the requested connection and information indicating whether the network slice specific authentication and authorization was successful or unsuccessful.

The method may comprise: receiving, from a network slice specific authentication and authorization function, a request for re-authorization of a user equipment for a network slice; executing network slice specific authentication and authorization for a connection of the user equipment associated with said network slice; and updating the locally stored information to indicate that the user equipment is authorized for the network slice associated with the connection.

The method may comprise releasing the one or more network connections for the user equipment associated with the network slice.

The method may comprise: receiving, from a network slice specific authentication and authorization function, a request for revocation of authorization of the user equipment for a network slice associated with one or more connections of the user equipment; based on the request for revocation, releasing the one or more network connections for the user equipment associated with the network slice; and updating the locally stored information and information stored at the home subscriber server entity and/or unified data management entity to indicate that the user equipment is no longer authorized for the network slice associated with the requested connection.

According to an aspect, there is provided a method comprising: sending, from a user equipment to a first entity, a request for a network connection, the request comprising information indicating whether the user equipment supports network slice specific authentication and authorization; and receiving, from the first entity and based on the request, information indication whether the request is accepted or rejected based on an outcome of a network slice specific authentication and authorization procedure for the user equipment for a network slice associated with the requested connection.

The outcome of the network slice specific authentication and authorization procedure may be: an outcome of a network slice specific authentication and authorization procedure performed in response to the request for the network connection; or an outcome of a network slice specific authentication and authorization procedure performed in response to an earlier request from the user equipment.

The method may comprise: establishing the requested network connection; receiving, from the first entity, an indication that the network connection is accepted but that network slice specific authentication and authorization is pending; and refraining from performing transmission using the requested network connection based on the indication that network slice specific authentication and authorization is pending.

The method may comprise: receiving, from the first entity, information indicating that the user equipment may perform transmission using the established network connection; or receiving, from the first entity, an instruction to release the network connection, and releasing the network connection based on the instruction.

According to an aspect, there is provided a method comprising: receiving, from a first entity, a request for an indication of whether network slice specific authentication and authorization status information is available for a user equipment and a network slice; determining, based on the request, whether there is network slice specific authentication and authorization status information available; and based on the determining, sending, to the first entity, a response comprising information indicating whether there is network slice specific authentication and authorization status information available.

The determining may comprise: checking for network slice specific authentication and authorization status information stored in association with any data connection involving the same network slice for the user equipment or any registration for the user equipment.

According to an aspect, there is provided a method comprising: receiving, at an access and mobility management function from a user equipment, a registration request associated with a network slice subject to network slice specific authentication and authorization; determining, based on the request, network slice specific authentication and authorization status information associated with the network slice subject to network slice specific authentication and authorization; and based on the determined status information, accepting or rejecting the request.

Determining the status information may comprise: determining the status information based on information stored at the access and mobility management function; or obtaining the status information from a unified data management function.

Determining the status information may comprise: performing a network slice specific authentication and authorization procedure based on the request; and determining the status information based on an outcome of the network slice specific authentication and authorization procedure.

The method may comprise: updating network slice specific authentication and authorization status information stored at the access and mobility management function and/or unified data management function based on an outcome of the network slice specific authentication and authorization procedure.

The accepting or rejecting the request may comprise: determining that the status information indicates that the user equipment is authorized and accepting the request; or determining that the status information indicates that the user equipment is not authorized and rejecting the request.

The method may comprise: sending, to the user equipment, information indicating whether the request is accepted or rejected.

The method may comprise: receiving a reauthorization request associated with an authorization of the user equipment; in response to the reauthorization request, performing network slice specific authentication and authorization procedure; and updating network slice specific authentication and authorization status information stored at the access and mobility management function based on an outcome of the network slice specific authentication and authorization procedure.

The method may comprise: updating, at a unified data management function, status information for the access and mobility management function based on an outcome of the network slice specific authentication and authorization procedure.

The method may comprise: receiving, at the access and mobility management function, a revocation request associated with an authorization of the user equipment for a given network slice; deleting the registration of the user equipment at the access and mobility management function for the given network slice; and updating network slice specific authentication and authorization status information stored at the access and mobility management function to indicate that the user equipment is not authorized for the given network slice.

The method may comprise: updating, at a unified data management function, status information for the access and mobility management function based on deleting the registration of the user equipment at the access and mobility management function for the given network slice.

According to an aspect, there is provided a computer readable medium comprising instructions which, when executed by an apparatus, cause the apparatus to perform at least the following: receiving, from a user equipment, a request for a network connection, the request comprising information indicating whether the user equipment supports network slice specific authentication and authorization; determining whether a network slice associated with the requested connection is subject to network slice specific authentication and authorization; determining, based on the request, whether the user equipment supports network slice specific authentication and authorization; and responsive to determining that the network slice is subject to network slice specific authentication and authorization and determining that the user equipment supports network slice specific authentication and authorization, accepting or rejecting the request based on information indicating the outcome of a network slice specific authentication and authorization procedure for the user equipment for the network slice associated with the requested connection.

The accepting or rejecting may comprise: determining whether there is locally stored information indicating that network slice specific authentication and authorization was previously executed successfully for the user equipment for the network slice associated with the requested connection; and accepting the request in response to determining that there is locally stored information indicating that network slice specific authentication and authorization was previously executed successfully for the user equipment for the network slice associated with the requested connection.

The locally stored information may comprise session information for the user equipment for the network slice associated with the requested connection or cached network slice specific authentication and authorization status information

The accepting or rejecting may comprise: requesting, from a home subscriber server and/or unified data management entity, an indication of whether network slice specific authentication and authorization status information is available for any first entity or access and mobility management function; receiving, from the home subscriber server and/or unified data management entity, a response comprising information indicating whether there is network slice specific authentication and authorization status information available; and accepting the request in response to determining that there is network slice specific authentication and authorization status information available indicating the network slice specific authentication and authorization was successful for the network slice associated with the requested connection; or rejecting the request in response to determining that the status information indicates the network slice specific authentication and authorization was not successfully executed for the network slice associated with the requested connection; or determining the need to perform network slice specific authentication and authorization when there is no network slice specific authentication and authorization status information available.

When there is status information available, the response may further comprise the status information for the network slice subject to network slice specific authentication and authorization.

The information indicating whether there is network slice specific authentication and authorization status information available may comprise information indicating whether there is network slice specific authentication and authorization status information available for any first entity or access and mobility management function.

The instructions, when executed by the apparatus, may cause the apparatus to further perform: responsive to determining the need to perform network slice specific authentication and authorization: establishing the requested network connection; sending, to the user equipment, an indication that network slice specific authentication and authorization is pending; and performing network slice specific authentication and authorization.

The indication may comprise information for causing the user equipment to refrain from performing transmission using the requested network connection.

The instructions, when executed by the apparatus, may cause the apparatus to further perform: accepting or rejecting the request based on a result of performing the network slice specific authentication and authorization; and when the request is accepted, sending, to the user equipment, information indicating that the request is accepted and that the user equipment may perform transmission using the established network connection; or when the request is rejected, releasing the network connection and sending an instruction to the user equipment to deactivate the network connection with an indication that the network slice specific authentication and authorization was not successfully executed for the network slice associated with the requested connection.

The instructions, when executed by the apparatus, may cause the apparatus to further perform: responsive to accepting or rejecting the request, locally storing information indicating that network slice specific authentication and authorization was previously executed for the user equipment for the network slice associated with the requested connection and information indicating whether the network slice specific authentication and authorization was successful or unsuccessful.

The instructions, when executed by the apparatus, may cause the apparatus to further perform: receiving, from a network slice specific authentication and authorization function, a request for re-authorization of a user equipment for a network slice; executing network slice specific authentication and authorization for a connection of the user equipment associated with said network slice; and updating the locally stored information to indicate that the user equipment is authorized for the network slice associated with the connection.

The instructions, when executed by the apparatus, may cause the apparatus to further perform releasing the one or more network connections for the user equipment associated with the network slice.

The instructions, when executed by the apparatus, may cause the apparatus to further perform: receiving, from a network slice specific authentication and authorization function, a request for revocation of authorization of the user equipment for a network slice associated with one or more connections of the user equipment; based on the request for revocation, releasing the one or more network connections for the user equipment associated with the network slice; and updating the locally stored information and information stored at the home subscriber server entity and/or unified data management entity to indicate that the user equipment is no longer authorized for the network slice associated with the requested connection.

According to an aspect, there is provided a computer readable medium comprising instructions which, when executed by an apparatus, cause the apparatus to perform at least the following: sending, from a user equipment to a first entity, a request for a network connection, the request comprising information indicating whether the user equipment supports network slice specific authentication and authorization; and receiving, from the first entity and based on the request, information indication whether the request is accepted or rejected based on an outcome of a network slice specific authentication and authorization procedure for the user equipment for a network slice associated with the requested connection.

The outcome of the network slice specific authentication and authorization procedure may be: an outcome of a network slice specific authentication and authorization procedure performed in response to the request for the network connection; or an outcome of a network slice specific authentication and authorization procedure performed in response to an earlier request from the user equipment.

The instructions, when executed by the apparatus, may cause the apparatus to further perform: establishing the requested network connection; receiving, from the first entity, an indication that the network connection is accepted but that network slice specific authentication and authorization is pending; and refraining from performing transmission using the requested network connection based on the indication that network slice specific authentication and authorization is pending.

The instructions, when executed by the apparatus, may cause the apparatus to further perform: receiving, from the first entity, information indicating that the user equipment may perform transmission using the established network connection; or receiving, from the first entity, an instruction to release the network connection, and releasing the network connection based on the instruction.

According to an aspect, there is provided a computer readable medium comprising instructions which, when executed by an apparatus, cause the apparatus to perform at least the following: receiving, from a first entity, a request for an indication of whether network slice specific authentication and authorization status information is available for a user equipment and a network slice; determining, based on the request, whether there is network slice specific authentication and authorization status information available; and based on the determining, sending, to the first entity, a response comprising information indicating whether there is network slice specific authentication and authorization status information available.

The determining may comprise: checking for network slice specific authentication and authorization status information stored in association with any data connection involving the same network slice for the user equipment or any registration for the user equipment.

According to an aspect, there is provided a computer readable medium comprising instructions which, when executed by an apparatus, cause the apparatus to perform at least the following: receiving, at an access and mobility management function from a user equipment, a registration request associated with a network slice subject to network slice specific authentication and authorization; determining, based on the request, network slice specific authentication and authorization status information associated with the network slice subject to network slice specific authentication and authorization; and based on the determined status information, accepting or rejecting the request.

Determining the status information may comprise: determining the status information based on information stored at the access and mobility management function; or obtaining the status information from a unified data management function.

Determining the status information may comprise: performing a network slice specific authentication and authorization procedure based on the request; and determining the status information based on an outcome of the network slice specific authentication and authorization procedure.

The instructions, when executed by the apparatus, may cause the apparatus to further perform: updating network slice specific authentication and authorization status information stored at the access and mobility management function and/or unified data management function based on an outcome of the network slice specific authentication and authorization procedure.

The accepting or rejecting the request may comprise: determining that the status information indicates that the user equipment is authorized and accepting the request; or determining that the status information indicates that the user equipment is not authorized and rejecting the request.

The instructions, when executed by the apparatus, may cause the apparatus to further perform: sending, to the user equipment, information indicating whether the request is accepted or rejected.

The instructions, when executed by the apparatus, may cause the apparatus to further perform: receiving a reauthorization request associated with an authorization of the user equipment; in response to the reauthorization request, performing network slice specific authentication and authorization procedure; and updating network slice specific authentication and authorization status information stored at the access and mobility management function based on an outcome of the network slice specific authentication and authorization procedure.

The instructions, when executed by the apparatus, may cause the apparatus to further perform: updating, at a unified data management function, status information for the access and mobility management function based on an outcome of the network slice specific authentication and authorization procedure.

The instructions, when executed by the apparatus, may cause the apparatus to further perform: receiving, at the access and mobility management function, a revocation request associated with an authorization of the user equipment for a given network slice; deleting the registration of the user equipment at the access and mobility management function for the given network slice; and updating network slice specific authentication and authorization status information stored at the access and mobility management function to indicate that the user equipment is not authorized for the given network slice.

The instructions, when executed by the apparatus, may cause the apparatus to further perform: updating, at a unified data management function, status information for the access and mobility management function based on deleting the registration of the user equipment at the access and mobility management function for the given network slice.

According to an aspect, there is provided a non-transitory computer readable medium comprising program instructions that, when executed by an apparatus, cause the apparatus to perform at least the method according to any of the preceding aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a representation of a network system according to some example embodiments;

FIG. 2 shows a representation of a control apparatus according to some example embodiments;

FIG. 3 shows a representation of an apparatus according to some example embodiments;

FIG. 4 shows an example network architecture;

FIG. 5 shows methods according to some examples;

FIG. 6 shows a method according to some examples;

FIG. 7 shows a signalling procedure according to some examples;

FIG. 8 shows an example network slice specific authentication and authorization procedure;

FIG. 9 shows an example re-authorizaiton procedure;

FIG. 10 shows an example revocation procedure;

FIG. 11 shows an example registration procedure;

FIG. 12 shows an example re-authentication procedure; and

FIG. 13 shows an example revocation procedure.

### DETAILED DESCRIPTION

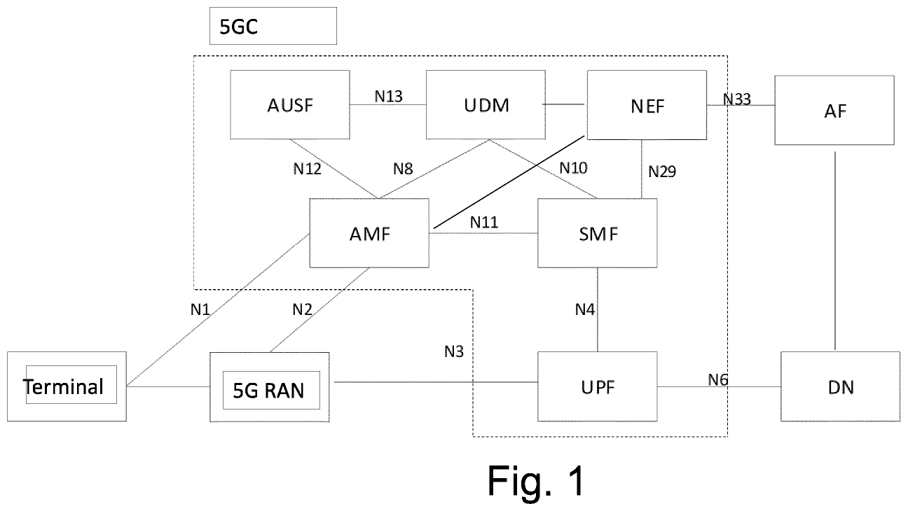

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may be comprised by a terminal or user equipment (UE), a 5G radio access network (5GRAN) or next generation radio access network (NG-RAN) or other 5G AN entities as defined in TS 23.501 such as N3IWF/TNGF/W-AGF, a 5G core network (5GC), one or more application function (AF) and one or more data networks (DN).

The 5G-RAN may comprise one or more gNodeB (GNB) or one or more gNodeB (GNB) distributed unit functions connected to one or more gNodeB (GNB) centralized unit functions. The 5GC may comprise the following entities: Network Slice Selection Function (NSSF); Network Exposure Function; Network Repository Function (NRF); Policy Control Function (PCF); Unified Data Management (UDM); Application Function (AF); Authentication Server Function (AUSF); an Access and Mobility Management Function (AMF); and Session Management Function (SMF). FIG. 1 also shows the various interfaces (N1, N2 etc.) that may be implemented between the various elements of the system.

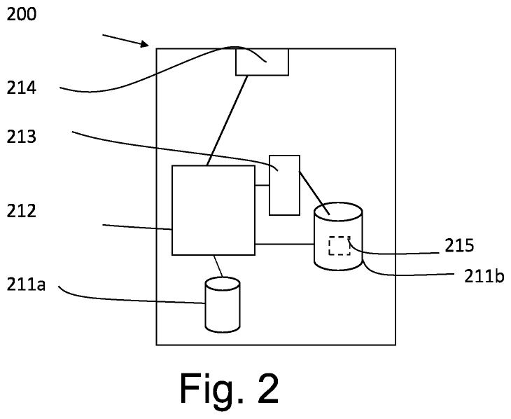

FIG. 2 illustrates an example of a control apparatus 200 for controlling a function of the 5GRAN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5GRAN or the 5GC. In some embodiments, each function of the 5GRAN or the 5GC comprises a control apparatus 200. In alternative embodiments, two or more functions of the 5GRAN or the 5GC may share a control apparatus.

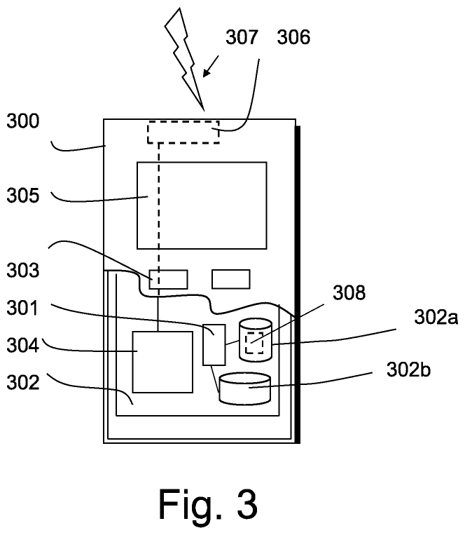

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as key pad 305, touch sensitive screen or pad, combinations thereof or the like. Optionally one or more of a display, a speaker and a microphone may be provided depending on the type of the device.

Some 5G networks may support the “Network Slice Specific Authentication and Authorization (NSSAA)” feature, for example as discussed in 3GPP TS 23.501. This feature may enable the authentication by means of the Extensible Authentication Protocol (EAP) of a User or User Equipment of a network slice which is configured to use this extra level of authentication and authorization, after the subscription to the network slice has been already authenticated and authorized using the normal 5GS primary authentication and the subscription information check. Re-authentication and revocation of authorization may also be supported.

A network slice data connectivity may in some implementations also be accessed from the Evolved Packet System (EPS) when the UE establishes a Public Data Network (PDN) connection that is associated to Single Network Slice Selection Assistance Information (S-NSSAI) of a network slice at the SMF and PDN Gateway Control plane function (PGW-C). The SMF+PGW-C may be considered a combined 5GS/EPS node, and may be used to enable intersystem mobility where it plays the role of the anchor across systems).

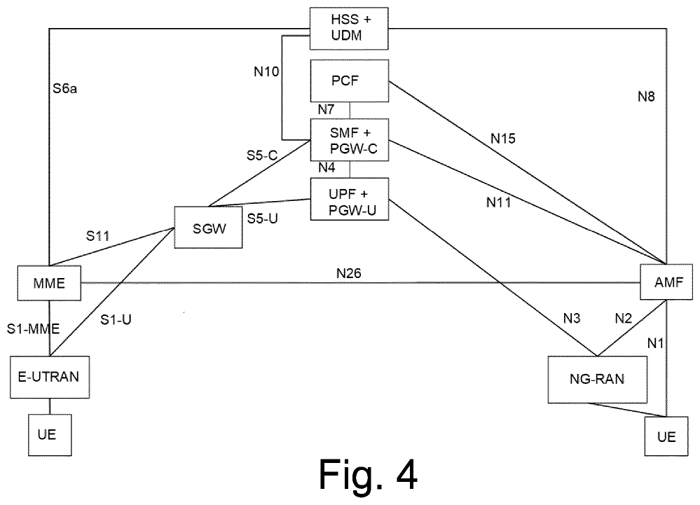

FIG. 4 shows an example interworking architecture according to 3GPP TS 23.501, where the SMF+PGW-C is used.

In some examples, when the S-NSSAI of a PDN connection is related to a network slice subject to NSSAA, however, the NSSAA may not be able to take place in EPS. The Mobility Management Entity (MME) may not perform this function either, as the UE and MME may not be able to perform registration per S-NSSAI (unlike in 5GS). This may create significant hurdles to adoption as the UE may be unable to use connectivity of these slices in the EPS.

More particularly, 3GPP TS 23.502 states that, while the UE is in EPS and it attempts to establish a PDN connection for an APN associated with a S-NSSAI that is subject to NSSAA, the UE and the SMF+PGW-C exchange information via PCO as described in clause 5.15.7 of TS 23.501. If the S-NSSAIs supported by the SMF+PGW-C are all subject to NSSAA, then the SMF+PGW-C should reject the PDN connection establishment.

Some examples may address some of these problems.

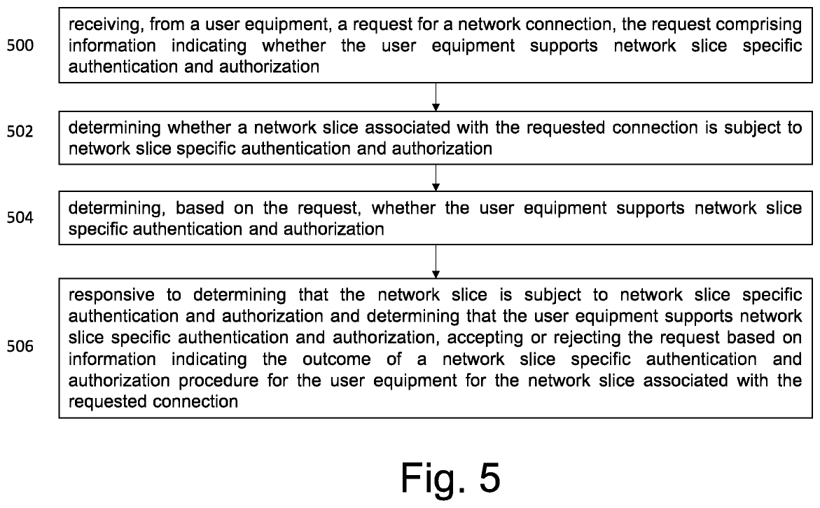

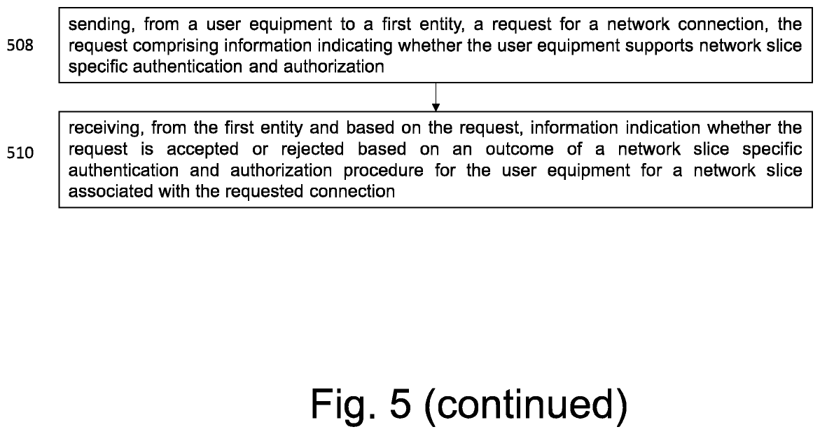

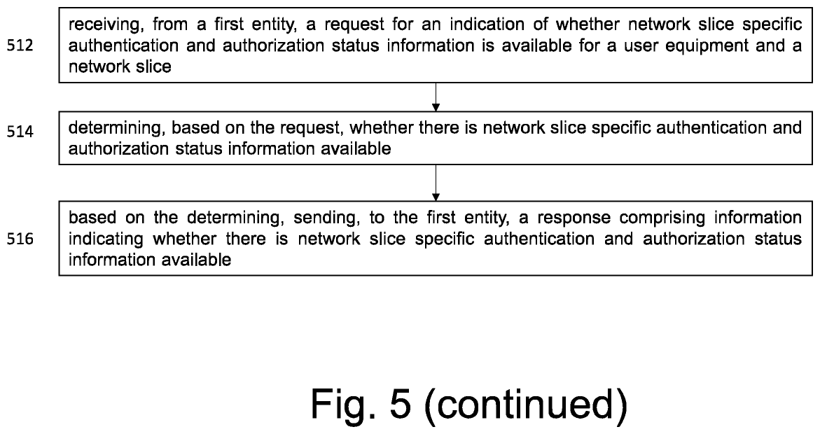

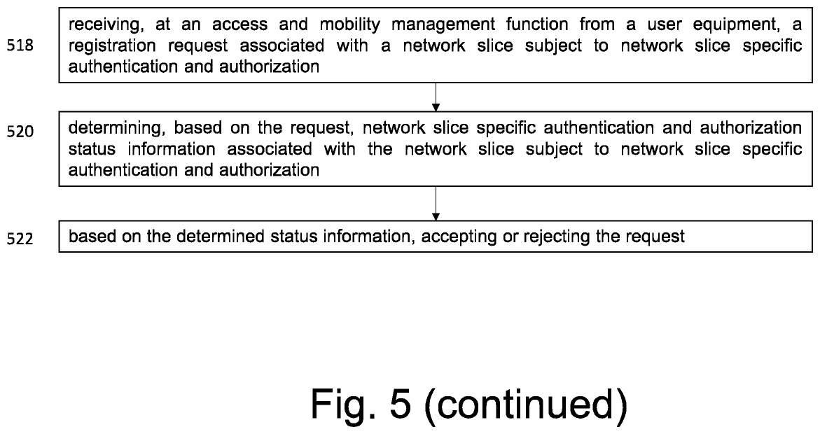

Reference is made to FIG. 5, which shows methods according to some examples.

At 500, a method comprises: receiving, from a user equipment, a request for a network connection, the request comprising information indicating whether the user equipment supports network slice specific authentication and authorization.

At 502, the method comprises: determining whether a network slice associated with the requested connection is subject to network slice specific authentication and authorization.

At 504, the method comprises: determining, based on the request, whether the user equipment supports network slice specific authentication and authorization.

At 506, the method comprises: responsive to determining that the network slice is subject to network slice specific authentication and authorization and determining that the user equipment supports network slice specific authentication and authorization, accepting or rejecting the request based on information indicating the outcome of a network slice specific authentication and authorization procedure for the user equipment for the network slice associated with the requested connection.

Steps 500-506 may, in some examples, be performed at or by a first entity, such as a SMF+PGW-C.

At 508, a method comprises: sending, from a user equipment to a first entity, a request for a network connection, the request comprising information indicating whether the user equipment supports network slice specific authentication and authorization.

At 510, the method comprises: receiving, from the first entity and based on the request, information indication whether the request is accepted or rejected based on an outcome of a network slice specific authentication and authorization procedure for the user equipment for a network slice associated with the requested connection.

Steps 508-510 may, in some examples, be performed at or by a UE.

At 512, a method comprises: receiving, from a first entity, a request for an indication of whether network slice specific authentication and authorization status information is available for a user equipment and a network slice.

At 514, the method comprises: determining, based on the request, whether there is network slice specific authentication and authorization status information available.

At 516, the method comprises: based on the determining, sending, to the first entity, a response comprising information indicating whether there is network slice specific authentication and authorization status information available.

Steps 512-516 may, in some examples, be performed at or by a UDM.

At 518, a method comprises: receiving, at an access and mobility management function from a user equipment, a registration request associated with a network slice subject to network slice specific authentication and authorization.

At 520, the method comprises: determining, based on the request, network slice specific authentication and authorization status information associated with the network slice subject to network slice specific authentication and authorization.

At 522, the method comprises: based on the determined status information, accepting or rejecting the request.

Steps 518-522 may, in some examples, be performed at or by an AMF.

In some examples, a first entity, such as a combined SMF+PGW-C or other entity configured to perform the same or similar functions, may be used to serve Access Point Names (APNs) mapping to Data Network Names (DNNs) associated with S-NSSAIs implementing NSSAA.

In some examples, the NSSAA may be implemented in combination or associated with an Authentication, Authorization and Accounting (AAA) server.

In some examples, the operation of the MME and SGW may not be impacted by the procedure. Some exchanges between the UE and the first entity for NSSAA may be carried via protocol configuration options (PCO/ePCO) information element, which is a transparent container defined for EPS session management messages. This may include the support of EAP exchanges between the UE and the AAA-server and indication the UE supports NSSAA in EPS and may carry EAP signaling required by NSSAA exchanges between the UE and a slice related AAA server.

In some examples, a message such as a Create PDN Connection Request message, may be sent by the UE to the first entity. The first entity may, upon retrieving subscription data for the UE, determine whether a network slice associated with the request is subject to NSSAA. For example, the first entity may detect the APN for which the session is requested is associated to a (DNN, S-NSSAI) for which the S-NSSAI is subject to NSSAA. The first entity may check whether the UE has indicated support of NSSAA procedure, for example in EPS in PCO information the UE sends to the network PDN Connection Request message when it requests a PDN connection to be established.

In some examples, if the UE does not support NSSAA, the PDN connection establishment may be rejected. The rejection may comprise an indication that the network slice associated with the request is subject to NSSAA.

In some examples, when the UE supports NSSAA, the first entity may determine whether it has locally stored information indicating that NSSAA has been previously executed for the UE for the network slice associated with the request. For example, the first entity may determine whether there is locally stored session information for the network slice associated with the request already established or it has cached NSSAA status information that indicates NSSAA was executed successfully for the UE for the network slice associated with the request already.

If so, the first entity may complete the PDN connection establishment based on the locally stored information.

If not, the first entity may check with Unified Data Management (UDM) (possibly including a a Home Subscriber Server (HSS)) by sending a message, such as a Nudm_UECM_Get. The message may request information indicating whether there is any stored information for any first entity or AMF that indicates whether NSSAA was previously successful for the user equipment for the network slice associated with the requested connection. The HSS/UDM may respond with an indication based on whether or not there is the requested information stored at the HSS/UDM.

If there is no available information, for example that the NSSAA was already successfully executed for the S-NSSAI associated with the APN, the PDN connection may be established and an indication may be provided to the UE in a PDN Connection establishment Response/accept Message indicating that NSSAA is pending for the S-NSSAI associated with the PDN connection. The indication may indicate that NSSAA will be executed so the UE knows it is not yet allowed to send any UL data and also not yet allowed to establish further sessions related to same S-NSSAI according to locally available information.

If there is information available for any AMF or first entity, and the information indicates NSSAA was previously successful for the user equipment for the network slice associated with the requested connection, the first entity may complete the PDN connection establishment successfully and enable data transmission.

If there is information available for any AMF or first entity, and the information indicates NSSAA was previously unsuccessful for the user equipment for the network slice associated with the requested connection, the first entity may reject the request for PDN connection establishment or may based on operator policy determine to initiate NSSAA.

In some examples, it may not be possible to exchange PCO between the UE and the first entity without first establishing the PDN connection. Therefore, in some examples, the PDN connection may be established before NSSAA has taken place. In such examples, UE UL transmission may be blocked (for example in response to the cause code “NSSAA pending” being set). That is to say, in some examples the first entity may block any UL/DL data for this PDN connection, i.e. as long as NSSAA has not been passed, the UE may not allowed to exchange User plane traffic over the PDN connection.

When NSSAA has successfully taken place, the first entity may allow traffic exchange at the UPF and may indicate to the UE that User plane traffic is now possible by NSSAA. The first entity may send an indication that User Plane traffic is allowed, for example in a PDN connection update message sent to the UE by the first entity.

When NSSAA is successful, the first entity may register successful NSSAA status for the first entity. When NSSAA fails, the PDN connection may be released by the first entity and the NSSAA status may be removed for the user equipment for the network slice associated with the requested connection. The first entity may indicate, to the UE, that the PDN connection is to be released due to NSSAA failure.

In some examples, EAP exchanges between the UE and the NSSAA function (NSSAAF) via the first entity may be carried over PCO. The first entity may not perform NSSAA for a PDN connection that is being handed over from 5GS unless the first entity triggers NSSAA, for example based on policy or request by a NSSAAF at any time. In some examples, when NSSAA has passed over 5GS, this may be indicated by the AMF, and the AMF may store this outcome in NSSAA status in the UDM. If NSSAA is revoked at 5GS or the UE is deregistered, the AMF may update its registration with UDM to remove the NSSAA staus.

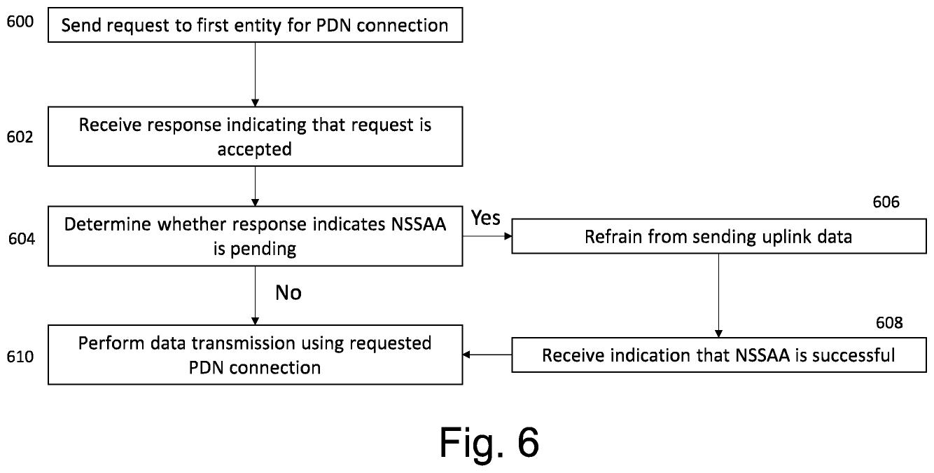

Reference is made to FIG. 6, which shows a method performed by a UE according to some examples.

At 600, the UE sends a request, to the first entity, to create a PDN connection. The requested connection may be for a particular APN. The request may comprise an indication that the UE supports NSSAA e.g. in PCO.

At 602, the UE receives a response from the first entity indicating that the request has been accepted. The response includes information identifying the network slice.

At 604, the UE determines whether the response includes an indication that NSSAA is pending or that data transfer is not yet allowed for the PDN connection.

If the determination at 604 is that there is an indication that NSSAA is pending or that data transfer is not yet allowed for the PDN connection, then at 606 the UE refrains from sending uplink data via the PDN connection. The UE may also refrain from requesting any other PDN connection associated with the network slice, for example based on rules for EPS associating the APN to a DNN for same network slice that the UE locally stores (e.g. in UE Route Selection Policy (URSP) information).

At 608, the UE receives, from the first entity, an indication that NSSAA was successful for the network slice or that data transfer is now allowed for the PDN connection.

At 610, in response to the determination at 604 being that there is not an indication that NSSAA is pending, or in response to receiving the indication that NSSAA was successful at 608, the UE performs uplink and/or downlink data transmission using the PDN connection. The UE may store the association between the PDN connection and the network slice, and may request other PDN connections for the same network slice, for example based on rules for EPS associating the APN to a DNN for same network slice.

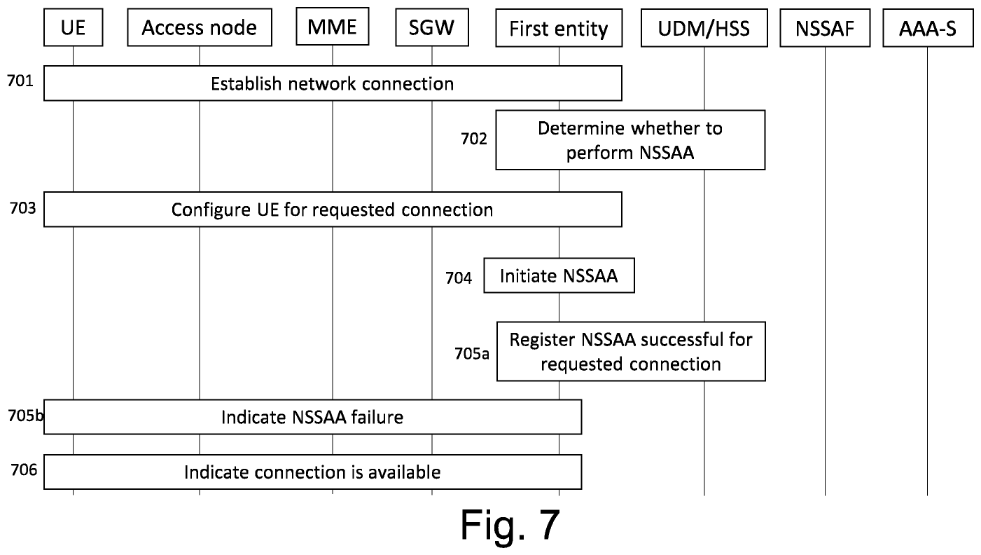

Reference is made to FIG. 7, which shows a signaling procedure according to some examples.

The procedure of FIG. 7 may assume that the UE is configured with credentials and identities for NSSAA for each network slice it needs to use subject to NSSAA prior to the procedure. The configuration may be performed by any suitable means, such as per 3GPP standards.

At 701, the UE establishes a network connection. For example, the UE may send a request for a network connection to the first entity. The request may comprise an indication of whether the UE supports NSSAA. The indication may be sent, for example, via PCO information sent to the first entity. The request may be sent as a dedicated request after the UE attached to the network or may be carried within an attach request to the network.

At 702 the first entity, receiving the request at 701, determines the network slice that is associated with the PDN connection, and determines whether to perform NSSAA. The determination may be based on configuration information and/or a subscription data check.

If the determined network slice is subject to NSSAA (for example determined by configuration or based on subscription data for the UE), the first entity may then determine whether the UE supports NSSAA.

When the first entity determines that the UE does not support the NSSAA, the first entity may reject the establishment of the PDN connection.

When the first entity determines that the UE supports NSSAA, the first entity may query the UDM (or Home Subscriber Server (HSS)) to check whether NSSAA has been passed for the UE on that slice. The query may in some examples comprise a Nudm_UECM_Get operation. The UDM may then check whether the UE is registered for the network slice of the requested connection locally, at an AMF on which the UE is registered or on another instance of the first entity.

The HSS/UDM, in response to the query, may indicate whether NSSAA has been passed for the UE on that slice by checking any NSSAA information associated with a 5GS registration for the UE or the successful establishment of PDU sessions.

If the first entity determines that NSSAA has been passed for the UE on that slice (there are PDN connections for the network slice and/or if NSSAA is registered as successful for the network slice in 5GS), the first entity may consider the user authorized. The first entity may then accept the PDN connection establishment.

At 703, before initiating NSSAA, the first entity may configure the UE for the requested connection. The first entity may configure the UE to prevent data transmission in UL/DL for the UE. For example, the first entity may cause, at the UPF/PGW-u, configuration of an Access Control List (ACL) to stop any traffic over the PDN Connection until the NSSAA has been performed and the result is successful (i.e. the UE is authorized/authenticated).

The first entity may provide a response to the UE. The response may comprise an indication (e.g. in PCO) that NSSAA is pending, alongside information identifying the network slice.

Based on the indication that NSSAA is pending, the UE may be informed that it is not allowed to send UL data and refrains from requesting other PDN connections for APNs associated with the same network slice based on URSP (UE Route Selection Policy)information it may hold.

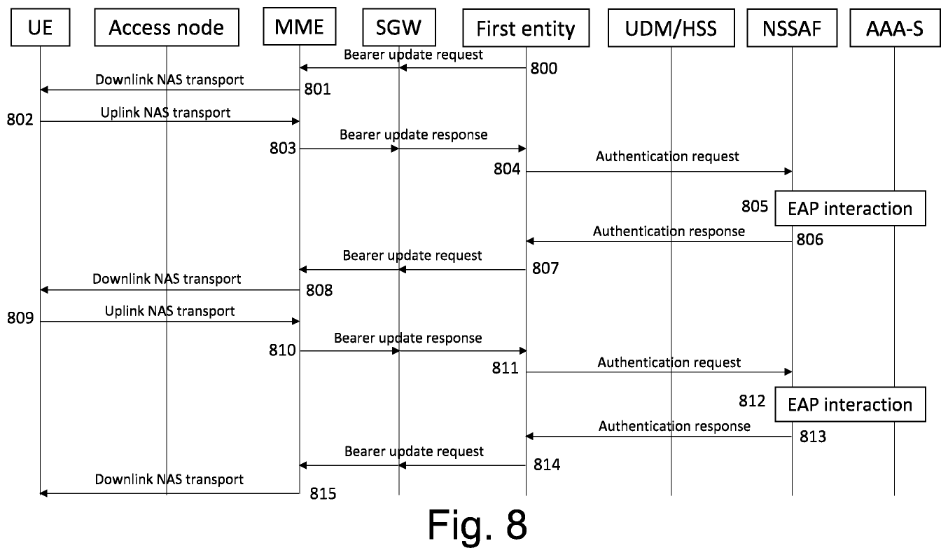

At 704, the first entity may initiate NSSAA. Any suitable method for performing NSSAA may be used. An example signalling exchange for performing NSSAA is described below in relation to FIG. 8.

At 705a, if the NSSAA is successful, the first entity may register the PDU session ID of the PDU session with UDM, including the address of the first entity and information identifying the network slice associated with it. Thus, the network slice may be recorded as successfully passing NSSAA for the UE (or in some examples may be indicated explicitly with information indicating “NSSAA success”). The information (NSSAA status, network slice identity information) may be provided to the UDM/HSS for connections that require NSSAA.

Step 706 may then be executed after step 705a.

At 705b, if the NSSAA failed, the first entity may send a message to the UE indicating NSSAA failure. The first entity may do so by instructing the UE to release or deactivate the PDN connection. For example, the first entity may send a Bearer Deactivation message indicating the bearers of the PDN connections need to be deleted and the cause set to NSSAA failure. The first entity may also instruct removal of PDN context for the UE at UPF/PGW-u.

Step 706 may not be executed after step 705b.

At 706, the first entity may notify the UE that the PDN connection is now available following NSSAA success. For example, the first entity may include an indication of NSSAA success, such as a “NSSAA success” IE in the PCO. The first entity may notify the UE via a bearer modification message without QoS update. The indication may also allow the UE to request other PDU sessions for the network slice. The first entity may also instruct the UPF/PGW-u to allow data transmission for the UE in UL/DL.

Reference is made to FIG. 8, which shows an example NSSAA procedure. As discussed above, the procedure shown in FIG. 8 may be executed at step 704 described above in relation to FIG. 7. It should be understood that the example shown in FIG. 8 and described below is only one example method for performing NSSAA, and that other signalling exchanges may be performed when performing the NSSAA procedure described above in step 704.

At 800, the first entity may send, via the SGW, a bearer update request to the MME. The request may comprise PCO/ePCO information including an EAP message such as an EAP ID request, and information indicating the network slice for which NSSAA is being performed.

At 801, the MME sends a NAS (as defined in TS 24.301) message to the UE, such as a downlink NAS transport message sent via the 5G AN, comprising the PCO/ePCO information including an EAP message such as an EAP ID request, and information indicating the network slice for which NSSAA is being performed.

At 802, the UE sends a NAS response to the message sent at 801, the response comprising the PCO/ePCO information including an EAP message such as an EAP ID response, and possibly information indicating the network slice for which NSSAA is being performed.

At 803, the MME sends, via the SGW, a bearer update response to the first entity. The bearer update response may comprise PCO/ePCO information including an EAP message such as an EAP ID response, and information indicating the network slice for which NSSAA is being performed.

At 804, the first entity sends, to the NSSAA function, an authentication request. The authentication request may comprise an EAP message such as an EAP ID response, an identifier of the UE (such as a generic public subscription identifier, GPSI), and information indicating the network slice for which NSSAA is being performed.

At 805, the NSSAA function, in combination with the AAA service, performs an EAP interaction to perform authentication based on the request.

At 806, the NSSAA function sends, to the first entity, an authentication response based on the outcome of the EAP interaction at 805.

At 807, the first entity sends, to the MME via the SGW, a bearer update request. The request may comprise PCO/ePCO information including an EAP message.

At 808, the MME sends a NAS message to the UE, such as a downlink NAS transport message sent via the 5G AN, comprising PCO/ePCO information including an EAP message.

At 809, the UE sends a response to the MME message sent at 808, the response comprising PCO/ePCO including an EAP message,.

At 810, the MME sends a bearer update response to the first entity. The response may comprise PCO/ePCO including an EAP message.

At 811, the first entity sends an authentication request to the NSSAAF. The authentication request may comprise an EAP message, an identifier of the UE, and information indicating the network slice for which NSSAA is being performed.

At 812, the NSSAA function, in combination with the AAA service, performs an EAP interaction to perform authentication based on the request.

At 813, the NSSAAF sends an authentication response to the first entity. The response may comprise an indication of whether the authentication was successful or failed, along with the identifier of the UE, and information indicating the network slice for which NSSAA is being performed.

At 814 the first entity sends a bearer update request to the MME via the SGW. The bearer update request may comprise PCO/ePCO including an indication of whether the authentication was successful or failed, and information indicating the network slice for which NSSAA is being performed.

At 815, the MME sends a message to the UE, such as a downlink NAS transport message sent via the 5G AN, comprising the PCO/ePCO including an indication of whether the authentication was successful or failed, and information indicating the network slice for which NSSAA is being performed.

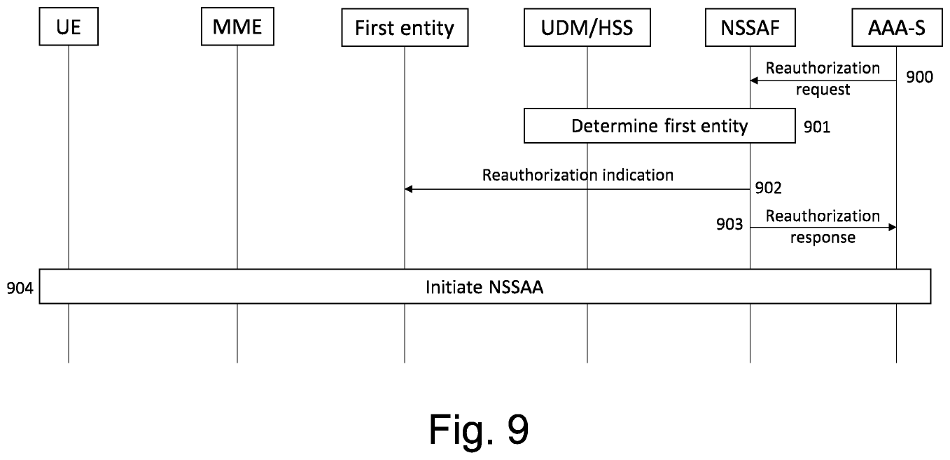

In some examples, a user may be re-authorized after an NSSAA procedure previously finds that the user is not authorized for a given network slice. An example procedure for re-authorization is shown in FIG. 9.

At 900, the AAA-S may trigger reauthorization of a UE identified by a user identifier (e.g. GPSI) in the network slice. For example, the AAA-S may send a reauthorization request to the NSSAAF. The request may comprise information identifying the UE and the network slice.

At 901, based on the request, the NSSAAF determines which node to send the reauthorization notification. For example the NSSAAF may check with the UDM/HSS whether any first entity for the network slice or AMF is registered for the UE.

At 902, if first entity addresses/IDs for which a PDN connection for the slice is registered are returned, then the NSSAAF may send a notification to one of the first entity addresses. The notification may comprise an indication that the user is to be re-authorized and/or reauthenticated.

At 903, having sent the notification to the first entity, the NSSAAF may also send a response to the AAA-S that requested reauthorization at 900.

At 904, the first entity that receives the notification from the NSSAAF at 902 may initiate NSSAA, for example as described above.

In some examples, if the reauthorization fails, the reauthorization process may be reinitiated up to a configurable amount of times, after which a revocation may be initiated.

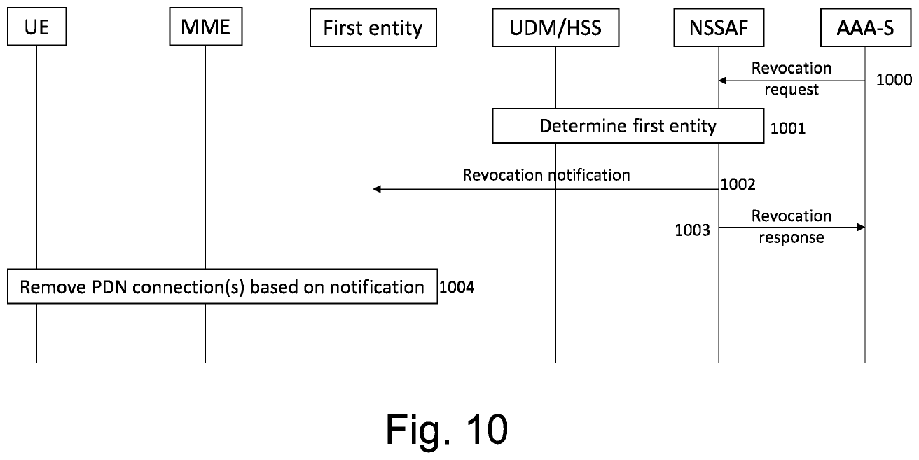

In some examples, the AAA-S may trigger revocation of authorization for a user. An example procedure for revocation is shown in FIG. 10.

At 1000, the AAA-S sends a revocation request to the NSSAAF. The request may comprise information identifying the UE and the network slice for which revocation is requested.

At 1001, based on the request, the NSSAAF determines which node to send the revocation notification to. For example the NSSAAF may check with the UDM/HSS whether any first entity for the network slice or AMF is registered for the UE.

At 1002 if first entity addresses/IDs for which a PDN connection for the slice is registered are returned, then the NSSAAF may send a notification to one or more of the first entity addresses. The notification may comprise an indication that the service is revoked for the user in the network slice. The notification may comprise information identifying the UE and the network slice.

At 1003, having sent the notification to the first entity, the NSSAAF may also send a response to the AAA-S that requested revocation at 1000.

At 1004, the one or more first entities may, based on the notification, remove the PDN connections in the network slice for the user identified in the request. For example, the first entities may send a deactivation notification, such as a Bearer Deactivation, indicating that the bearers of the PDN connection(s) need to be deleted for each PDN connection associated to the network slice and user the first entity supports.

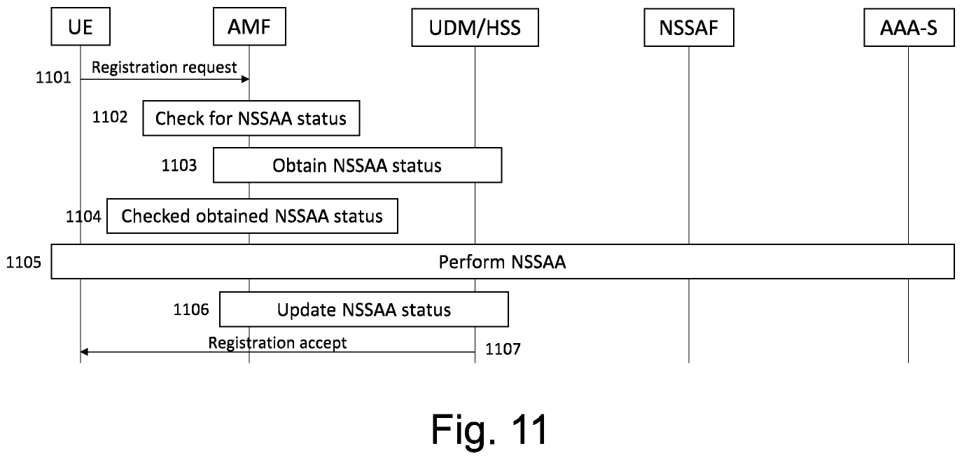

Reference is made to FIG. 11, which shows a registration procedure according to some examples.

At 1101, a UE sends a registration request associated with a network slice subject to NSSAA to the AMF.

At 1102, the AMF checks the NSSAA status for the UE and information associated with network slice in the stored UE context (if any is available). If the AMF finds that the NSSAA status indicates that the UE is already authorized then all remaining steps in FIG. 11 except step 1107 may be skipped. Otherwise the AMF may continue with step 1103.

At 1103, the AMF queries the UDM to obtain the NSSAA status for the UE registered in the UDM if any from first entities or any AMFs.

At 1104, the AMF checks the NSSAA status obtained from the UDM. If the NSSAA status indicates that the UE is already authorized for the network slice then all remaining steps in FIG. 11 except step 1107 may be skipped, otherwise the AMF continues with step 1105.

At 1105, NSSAA is executed, for example using the previously described procedures.

At 1106, if NSSAA is successful the UDM is updated with the successful outcome as the AMF registers or updates its registration status with UDM to add the NSSAA outcome.

If NSSAA is not successful the network slice is not included in allowed network slice information in step 1107.

At 1107, the AMF sends a registration accept response to the UE. The response comprises information identifying allowed network slice(s) (e.g. a list of allowed network slices). When the NSSAA is successful, the network slice from step 1101 is included in the list of allowed network slices, and when the NSSAA is unsuccessful, the network slice from step 1101 is not included in the list of allowed network slices.

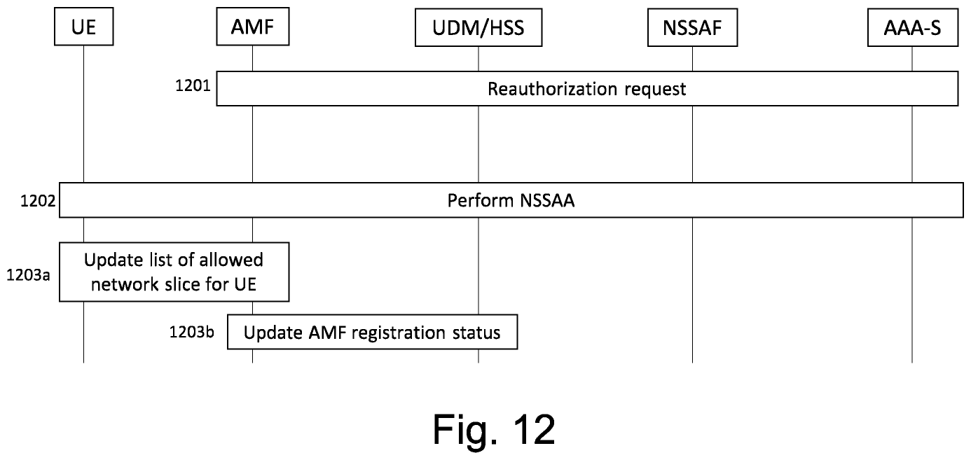

Reference is made to FIG. 12, which shows a reauthentication procedure according to some examples.

At 1201, the AAA-S requests the reauthentication/authorization of the user equipment for the network slice subject to NSSAA, for example as described previously.

At 1202, NSSAA takes place, for example as described previously. If the NSSAA is successful, step 1203 may be skipped.

At 1203a, the AMF updates the information identifying allowed network slice(s) for the UE by removing the information identifying the network slice for which NSSAA has failed.

At 1203b, the AMF updates its registration status with UDM to remove the network slice from NSSAA information comprising the list of authorized network slice(s) associated with the AMF stored at the UDM.

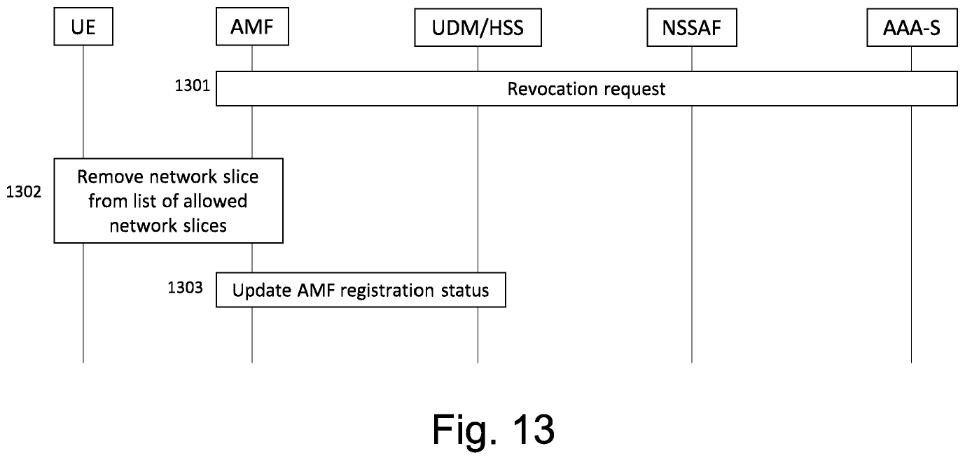

Reference is made to FIG. 13, which shows a revocation procedure according to some examples.

At 1301, the AAA-S requests the revocation of the network slice subject to NSSAA.

At 1302, the AMF updates the information identifying the allowed network slice(s) for the UE by removing the revoked network slice.

At 1303, the AMF updates its registration status with UDM to remove the network slice from NSSAA information comprising the list of authorized network slice(s) associated with the AMF stored at the UDM.

Thus, in some examples, a first entity, such as a SMF+PGW-C, may determine, based on a request from a UE, whether a network slice associated with a network connection is subject to NSSAA. When the UE supports NSSAA and the network slice is subject to NSSAA, the first entity may either complete connection establishment for the UE subject to successful NSSAA procedure or reject the request if NSSAA is unsuccessful or cannot be completed. While NSSAA is ongoing, the first entity may indicate to the UE that NSSAA is pending, whereupon the UE may not perform UL/DL transmissions for the requested connection until the result of the NSSAA is confirmed by the first entity.

In some examples, there is provided an apparatus comprising means for: receiving, from a user equipment, a request for a network connection, the request comprising information indicating whether the user equipment supports network slice specific authentication and authorization; determining whether a network slice associated with the requested connection is subject to network slice specific authentication and authorization; determining, based on the request, whether the user equipment supports network slice specific authentication and authorization; and responsive to determining that the network slice is subject to network slice specific authentication and authorization and determining that the user equipment supports network slice specific authentication and authorization, accepting or rejecting the request based on information indicating the outcome of a network slice specific authentication and authorization procedure for the user equipment for the network slice associated with the requested connection.

In some examples, the apparatus may comprise at least one processor and at least one memory storing instructions that, when executed by the at least one processor, cause the apparatus at least to: receive, from a user equipment, a request for a network connection, the request comprising information indicating whether the user equipment supports network slice specific authentication and authorization; determine whether a network slice associated with the requested connection is subject to network slice specific authentication and authorization; determine, based on the request, whether the user equipment supports network slice specific authentication and authorization; and responsive to determining that the network slice is subject to network slice specific authentication and authorization and determining that the user equipment supports network slice specific authentication and authorization, accept or reject the request based on information indicating the outcome of a network slice specific authentication and authorization procedure for the user equipment for the network slice associated with the requested connection.

In some examples, there is provided an apparatus comprising means for: sending, from a user equipment to a first entity, a request for a network connection, the request comprising information indicating whether the user equipment supports network slice specific authentication and authorization; and receiving, from the first entity and based on the request, information indication whether the request is accepted or rejected based on an outcome of a network slice specific authentication and authorization procedure for the user equipment for a network slice associated with the requested connection.

In some examples, the apparatus may comprise at least one processor and at least one memory storing instructions that, when executed by the at least one processor, cause the apparatus at least to: send, from a user equipment to a first entity, a request for a network connection, the request comprising information indicating whether the user equipment supports network slice specific authentication and authorization; and receive, from the first entity and based on the request, information indication whether the request is accepted or rejected based on an outcome of a network slice specific authentication and authorization procedure for the user equipment for a network slice associated cwith the requested connection.

In some examples, there is provided an apparatus comprising means for: receiving, from a first entity, a request for an indication of whether network slice specific authentication and authorization status information is available for a user equipment and a network slice; determining, based on the request, whether there is network slice specific authentication and authorization status information available; and based on the determining, sending, to the first entity, a response comprising information indicating whether there is network slice specific authentication and authorization status information available.

In some examples, the apparatus may comprise at least one processor and at least one memory storing instructions that, when executed by the at least one processor, cause the apparatus at least to: receive, from a first entity, a request for an indication of whether network slice specific authentication and authorization status information is available for a user equipment and a network slice; determine, based on the request, whether there is network slice specific authentication and authorization status information available; and based on the determining, send, to the first entity, a response comprising information indicating whether there is network slice specific authentication and authorization status information available.

In some examples, there is provided an apparatus comprising means for: receiving, at an access and mobility management function from a user equipment, a registration request associated with a network slice subject to network slice specific authentication and authorization; determining, based on the request, network slice specific authentication and authorization status information associated with the network slice subject to network slice specific authentication and authorization; and based on the determined status information, accepting or rejecting the request.

In some examples, the apparatus may comprise at least one processor and at least one memory storing instructions that, when executed by the at least one processor, cause the apparatus at least to: receive, at an access and mobility management function from a user equipment, a registration request associated with a network slice subject to network slice specific authentication and authorization; determine, based on the request, network slice specific authentication and authorization status information associated with the network slice subject to network slice specific authentication and authorization; and based on the determined status information, accept or reject the request.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1-25. (canceled)

26. An apparatus comprising: at least one processor; and at least one memory storing instructions that, when executed by the at least one processor, cause the apparatus at least to perform:
receiving, from a user equipment, a request for a network connection, the request comprising information indicating whether the user equipment supports network slice specific authentication and authorization;
determining whether a network slice associated with the requested connection is subject to network slice specific authentication and authorization;
determining, based on the request, whether the user equipment supports network slice specific authentication and authorization; and
responsive to determining that the network slice is subject to network slice specific authentication and authorization and determining that the user equipment supports network slice specific authentication and authorization, accepting or rejecting the request based on information indicating the outcome of a network slice specific authentication and authorization procedure for the user equipment for the network slice associated with the requested connection.

27. The apparatus of claim 26, wherein the accepting or rejecting comprises:
determining whether there is locally stored information indicating that network slice specific authentication and authorization was previously executed successfully for the user equipment for the network slice associated with the requested connection; and
accepting the request in response to determining that there is locally stored information indicating that network slice specific authentication and authorization was previously executed successfully for the user equipment for the network slice associated with the requested connection.

28. The apparatus of claim 27, wherein the locally stored information comprises session information for the user equipment for the network slice associated with the requested connection or cached network slice specific authentication and authorization status information

29. The apparatus of claim 26, wherein the accepting or rejecting comprises:
requesting, from a home subscriber server and/or unified data management entity, an indication of whether network slice specific authentication and authorization status information is available for any first entity or access and mobility management function;
receiving, from the home subscriber server and/or unified data management entity, a response comprising information indicating whether there is network slice specific authentication and authorization status information available; and
accepting the request in response to determining that there is network slice specific authentication and authorization status information available indicating the network slice specific authentication and authorization was successful for the network slice associated with the requested connection; or
rejecting the request in response to determining that the status information indicates the network slice specific authentication and authorization was not successfully executed for the network slice associated with the requested connection; or
determining the need to perform network slice specific authentication and authorization when there is no network slice specific authentication and authorization status information available.

30. The apparatus of claim 29, wherein when there is status information available, the response further comprises the status information for the network slice subject to network slice specific authentication and authorization.

31. The apparatus of claim 29, wherein the information indicating whether there is network slice specific authentication and authorization status information available comprises information indicating whether there is network slice specific authentication and authorization status information available for any first entity or access and mobility management function.

32. The apparatus of claim 29, wherein the apparatus is further caused to perform:
responsive to determining the need to perform network slice specific authentication and authorization:
establishing the requested network connection;
sending, to the user equipment, an indication that network slice specific authentication and authorization is pending; and
performing network slice specific authentication and authorization.

33. The apparatus of claim 32, wherein the indication comprises information for causing the user equipment to refrain from performing transmission using the requested network connection.

34. The apparatus of claim 32 wherein the apparatus is further caused to perform:
accepting or rejecting the request based on a result of performing the network slice specific authentication and authorization; and
when the request is accepted, sending, to the user equipment, information indicating that the request is accepted and that the user equipment may perform transmission using the established network connection; or
when the request is rejected, releasing the network connection and sending an instruction to the user equipment to deactivate the network connection with an indication that the network slice specific authentication and authorization was not successfully executed for the network slice associated with the requested connection.

35. The apparatus of claim 26, wherein the apparatus is further caused to perform: responsive to accepting or rejecting the request, locally storing information indicating that network slice specific authentication and authorization was previously executed for the user equipment for the network slice associated with the requested connection and information indicating whether the network slice specific authentication and authorization was successful or unsuccessful.

36. An apparatus comprising: at least one processor; and at least one memory storing instructions that, when executed by the at least one processor, cause the apparatus at least to perform:
sending, from a user equipment to a first entity, a request for a network connection, the request comprising information indicating whether the user equipment supports network slice specific authentication and authorization;
receiving, from the first entity and based on the request, information indication whether the request is accepted or rejected based on an outcome of a network slice specific authentication and authorization procedure for the user equipment for a network slice associated with the requested connection.

37. The apparatus of 36, wherein the outcome of the network slice specific authentication and authorization procedure is:
an outcome of a network slice specific authentication and authorization procedure performed in response to the request for the network connection; or
an outcome of a network slice specific authentication and authorization procedure performed in response to an earlier request from the user equipment, which was stored in the network first entity and/or in the Home subscriber server entity and/or Unified Data Management.

38. The apparatus of claim 36, wherein the apparatus is further caused to perform:
establishing the requested network connection;
receiving, from the first entity, an indication that the network connection is accepted but that network slice specific authentication and authorization is pending; and
refraining from performing transmission using the requested network connection based on the indication that network slice specific authentication and authorization is pending.

39. The apparatus of claim 36, wherein the apparatus is further caused to perform:
establishing the requested network connection;
receiving, from the first entity, information indicating that the user equipment may perform transmission using the established network connection; or
receiving, from the first entity, an instruction to release the network connection, and releasing the network connection based on the instruction.

40. An apparatus comprising: at least one processor; and at least one memory storing instructions that, when executed by the at least one processor, cause the apparatus at least to perform:
receiving, from a first entity, a request for an indication of whether network slice specific authentication and authorization status information is available for a user equipment and a network slice;
determining, based on the request, whether there is network slice specific authentication and authorization status information available; and
based on the determining, sending, to the first entity, a response comprising information indicating whether there is network slice specific authentication and authorization status information available.
